(19) United States
(12) Patent Application Publication
(10) Pub. No.: US 2026/0152357 A1
(43) Pub. Date: Jun. 4, 2026

(54) Transport Facility

(71) Applicant: Daifuku Co., Ltd., Osaka-shi (JP)

(72) Inventors: Fumiaki Tatemi, Tokyo (JP); Masaya Miyamoto, Tokyo (JP)

(21) Appl. No.: 19/123,841

(22) PCT Filed: Aug. 21, 2023
(86) PCT No.: PCT/JP2023/029959

§ 371 Date: Apr. 24, 2025

(30) Foreign Application Priority Data
Oct. 25, 2022 (JP) 2022-170854

(51) Int. Cl. B65G 63/00; G05D 1/644; G05D 105/28; G05D 107/70

(52) U.S. Cl. CPC B65G 63/002; G05D 1/644; G05D 2105/28; G05D 2107/70

(57) ABSTRACT

Reference points (P) included in a reference point group (PG) are arranged to define, as a travel path, a first path (R1), a second path (R2), a third path (R3), a fourth path (R4), a fifth path (R5), and a sixth path (R6). The first path (R1) and the second path (R2) extend toward a first side (X1) in a first direction. The third path (R3) and the fourth path (R4) extend toward a second side (X2) in the first direction. The fifth path (R5) extends toward a first side (Y1) in a second direction. The sixth path (R6) extends toward a second side (Y2) in the second direction. Four paths including the second path (R2), the third path (R3), the fifth path (R5), and the sixth path (R6) define, on a travel surface (11), an area (T) including a standby area (W) in which a transport vehicle (1) waits.

### CROSS-REFERENCE TO RELATED APPLICATIONS

This application is the United States national phase of International Patent Application No. PCT/JP2023/029959 filed Aug. 21, 2023, and claims priority to Japanese Patent Application No. 2022-170854 filed Oct. 25, 2022, the disclosures of which are hereby incorporated by reference in their entireties.

### BACKGROUND OF THE INVENTION

Field of the Invention

The present invention relates to a transport facility including a travel area with a reference point group including multiple reference points and a transport vehicle for transporting an article by traveling along a travel path connecting the reference points included in the reference point group.

### Description of Related Art

An article sorting facility is described in Japanese Unexamined Patent Application Publication No. 2020-11790 (JP 2020-11790) as an example of a transport facility for transporting articles. Reference signs in parentheses used hereafter in describing the background are the reference signs in JP 2020-11790. In the article sorting facility described in JP 2020-11790,article transport vehicles (4) for transporting articles (W) travel along a predefined lane. The structure shown in FIG. 1 in JP 2020-11790 includes a travel lane (L1), a branch lane (L2), and a completion lane (L3) on which the article transport vehicles (4) travel in the same direction (hereafter, downstream), and a return lane (L4) on which the article transport vehicles (4) travel in a direction (hereafter, upstream) opposite to the direction in which the article transport vehicles (4) travel on these three lanes.

In the structure shown in FIGS. 1 and 2 in JP 2020-11790, multiple work areas (E1) for picking articles (W) are aligned along the travel lane (L1). The travel lane (L1) includes lane areas (LE) corresponding to the respective work areas (E1). Each article transport vehicle (4) sequentially travels through one or more lane areas (LE) in which the picking operation is performed with the article transport vehicle (4). The article transport vehicle (4) travels downstream while changing lanes between the travel lane (L1), the branch lane (L2), and the completion lane (L3). After the picking operation, the article transport vehicle (4) travels to the downstream end and then travels along the return lane (L4) to return to the upstream end.

In such a transport facility as described in JP 2020-11790, a transport vehicle may not enter a traveling destination (a lane area corresponding to a work area in JP 2020-11790) for the transport vehicle when, for example, another transport vehicle is at the destination. The transport vehicle thus waits on the lane until the transport vehicle can enter the destination. The transport vehicle waiting on the lane is to be avoided by other transport vehicles, obstructing smooth traveling of the other transport vehicles.

### SUMMARY OF THE INVENTION

In view of the foregoing, a transport facility is awaited for allowing a transport vehicle to wait while being least likely to affect other traveling transport vehicles.

A transport facility according to an aspect of the disclosure includes a travel area including a reference point group including a plurality of reference points, and a transport vehicle that transports an article by traveling along a travel path connecting the plurality of reference points included in the reference point group. The plurality of reference points included in the reference point group are arranged to be capable of defining, as the travel path, a first path, a second path, a third path, a fourth path, a fifth path, and a sixth path. The first path extends toward a first side in a first direction along a travel surface on which the transport vehicle travels in the travel area. The second path is disposed on a first side in a second direction relative to the first path and extends toward the first side in the first direction. The second direction is a direction along the travel surface and intersecting with the first direction. The third path is disposed on the first side in the second direction relative to the second path and extends toward a second side in the first direction. The fourth path is disposed on the first side in the second direction relative to the third path and extends toward the second side in the first direction. The fifth path extends toward the first side in the second direction and intersects with the second path and the third path to connect the first path to the fourth path. The sixth path extends toward a second side in the second direction and intersects with the second path and the third path at a different position from the fifth path in the first direction to connect the first path to the fourth path. Four paths being the second path, the third path, the fifth path, and the sixth path define, on the travel surface, an area including at least one standby area in which the transport vehicle waits.

This structure can define, using multiple reference points included in the reference point group, two paths (more specifically, the first path and the second path) extending toward the first side in the first direction and two paths (more specifically, the third path and the fourth path) extending toward the second side in the first direction opposite to the first side in the first direction. This structure can further define two paths (more specifically, the fifth path and the sixth path) extending toward the opposite sides in the second direction at different positions in the first direction to connect the four paths. In this manner, the travel paths extending toward both the sides in the first direction and the travel paths extending toward both the sides in the second direction are directly or indirectly connectable to one another. Thus, the travel paths extending to the destinations for the transport vehicle can be defined as appropriate.

In this structure, the four paths being the second path, the third path, the fifth path, and the sixth path define, on the travel surface, the standby area in which the transport vehicle waits. The transport vehicle in the standby area defined as described above can wait without interfering with other transport vehicles traveling along these four paths. This allows the transport vehicle to wait while being least likely to affect other traveling transport vehicles.

Further aspects and features of the transport facility will be apparent from embodiments described below with reference to the drawings.

### BRIEF DESCRIPTION OF THE DRAWINGS

FIG. 1 is a plan view of a transport facility showing an example layout.

FIG. 2 is a plan view of an area around a standby area in the transport facility, showing an example layout.

FIG. 3 is a plan view of an area around the standby area in the transport facility, showing another example layout.

### DESCRIPTION OF THE INVENTION

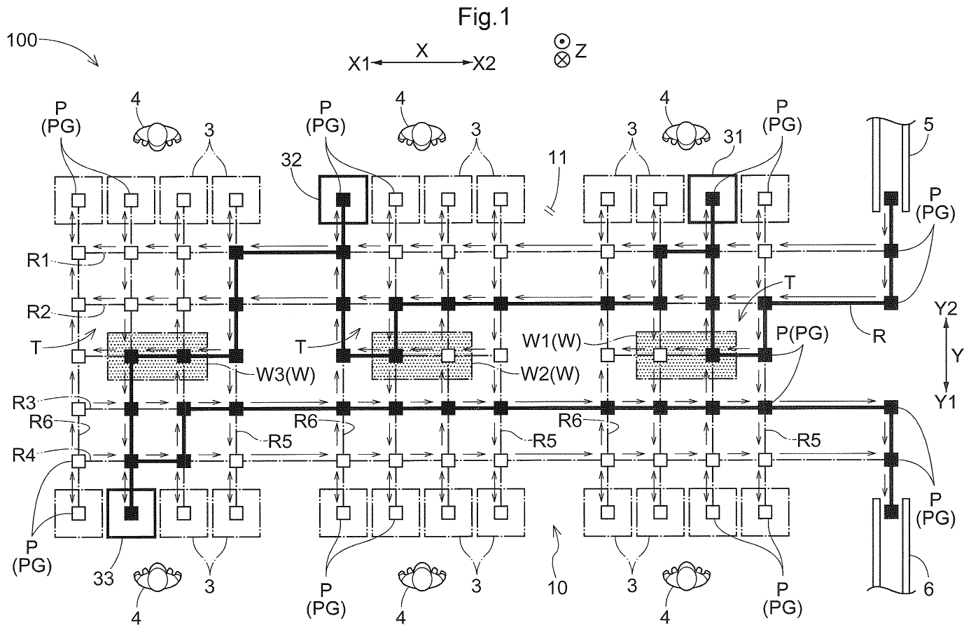

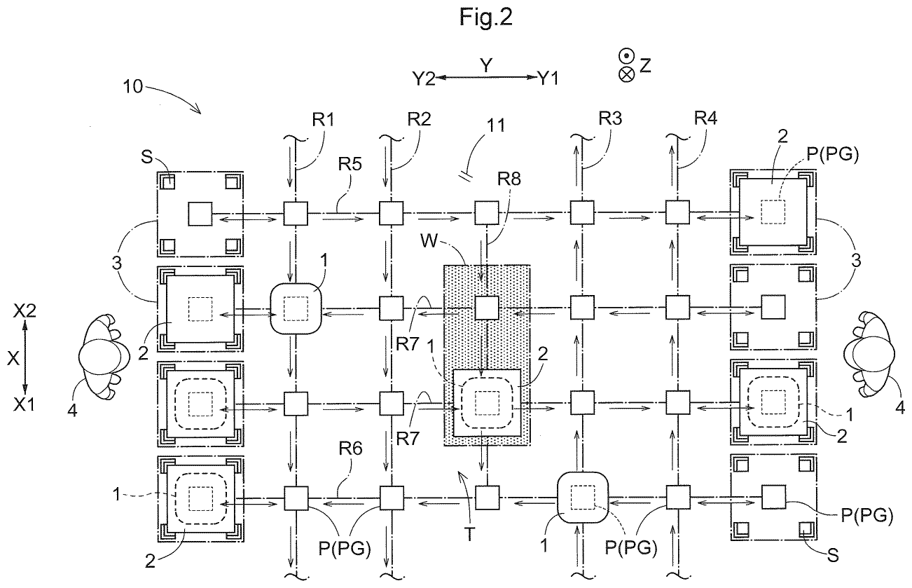

A transport facility according to an embodiment will be described with reference to the drawings. As shown in FIGS. 1 and 2, a transport facility 100 includes a travel area 10 and transport vehicles 1. Although the transport vehicles 1 are not shown in FIG. 1, the transport facility 100 includes multiple transport vehicles 1 as shown in FIG. 2. Each transport vehicle 1 travels along a travel path R to transport an article 2. The travel path R illustrated in FIG. 1 is a path from an infeeder 5 to an outfeeder 6 through a transfer area 3 (multiple transfer areas 3 in this example) described later. The infeeder 5 and the outfeeder 6 each include, for example, a conveyor for transporting articles 2.

The transport facility 100 further includes the transfer areas 3 in which the articles 2 are transferred from and to the transport vehicles 1. The articles 2 are transferred by, for example, an operator 4, a robot, a device installed on each transport vehicle 1, or two or three of these operating in cooperation with one another in the transfer area 3. In the examples shown in FIGS. 1 and 2, the articles 2 are transferred by operators 4 in the transfer areas 3.

Each transport vehicle 1 travels with travel wheels rotated under a driving force from, for example, a drive source such as an electric motor. In the present embodiment, the transport vehicle 1 can turn about an axis (about an axis extending in a vertical direction Z in the present embodiment) perpendicular to a travel surface 11. The transport vehicle 1 is an automated guided vehicle that travels along the travel path R autonomously or by remote control. In the present embodiment, the transport vehicle 1 autonomously travels along the travel path R. The transport vehicle 1 can travel while supporting an article 2. In the present embodiment, the transport vehicle 1 can travel while supporting the article 2 from below.

Although illustrated in a simplified manner in FIG. 2, each article 2 is, for example, a pallet and a load (a single load or multiple loads) placed on the pallet, or a container (e.g., a container with its upper surface being open) and a load (a single load or multiple loads) stored in the container. For the article 2 that is a support such as a pallet or a container and a load supported by the support as described above, the load is transferred from or to the transport vehicle 1 (more specifically, the support supported by the transport vehicle 1) in the transfer area 3 in the present embodiment. In the example shown in FIG. 2, each transfer area 3 includes a support unit S for supporting the article 2 (more specifically, the support). The load is transferred with the support being supported by the support unit S. Thus, the transport vehicle 1 can leave the transfer area 3 before the load transfer operation is complete.

For an assorting operation for collecting a load from the transport vehicle 1 in the transfer area 3, the load is transferred from the transport vehicle 1, or more specifically, is unloaded from the support supported by the transport vehicle 1. In this case, for example, the support supporting the load to be assorted is fed into the infeeder 5 by, for example, a conveyor. The transport vehicle 1 then transports the support from the infeeder 5 to the transfer area 3. The transport vehicle 1 sequentially travels through one or more transfer areas 3 in which the load is unloaded from the support, and then transports the support to the outfeeder 6.

For a picking operation for collecting a load onto the transport vehicle 1 in the transfer area 3, the load is transferred to the transport vehicle 1, or more specifically, loaded onto the support supported by the transport vehicle 1. In this case, for example, an empty support with no load is fed into the infeeder 5 by, for example, a conveyor, and the transport vehicle 1 transports the support from the infeeder 5 to the transfer area 3. The transport vehicle 1 sequentially travels through one or more transfer areas 3 in each of which the load is loaded onto the support, and then transports the support to the outfeeder 6.

As shown in FIGS. 1 and 2, a specific direction along the travel surface 11 on which the transport vehicle 1 travels in the travel area 10 is herein referred to as a first direction X. A direction along the travel surface 11 and intersecting with the first direction X is referred to as a second direction Y. In the present embodiment, a direction along the travel surface 11 and perpendicular to the first direction X is referred to as the second direction Y. One side in the first direction X is referred to as a first side X1 in the first direction, and the other side in the first direction X is referred to as a second side X2 in the first direction. One side in the second direction Y is referred to as a first side Y1 in the second direction, and the other side in the second direction Y is referred to as a second side Y2 in the second direction. In the example shown in FIG. 1, a side in the first direction X on which the transfer areas 3 are arranged relative to the infeeder 5 and the outfeeder 6 is referred to as the first side X1 in the first direction. A side in the second direction Y on which the outfeeder 6 is disposed relative to the infeeder 5 is referred to as the first side Y1 in the second direction. In the present embodiment, the travel surface 11 extends along a horizontal plane, and both the first direction X and the second direction Y are horizontal. The travel surface 11 includes, for example, a floor surface.

The travel area 10 includes a reference point group PG including multiple reference points P. The reference points P are at reference positions for the transport vehicle 1 to travel. Each reference point P is used as a reference for a stop position or a turn position for the transport vehicle 1. In the example shown in FIG. 1, multiple reference points P are arranged in the first direction X and in the second direction Y. In this example, the reference points P are arranged in a grid (e.g., a square grid) in the first direction X and the second direction Y. For simplicity, some of the reference points P are shown in FIG. 1.

The transport vehicle 1 travels to a destination while traveling straight through the reference points P and turning (an example of direction change) at reference points P. For example, the transport vehicle 1 travels to a destination while traveling straight through the reference points P in the first direction X, traveling straight through the reference points P in the second direction Y, and turning in 90-degree increments (e.g., turning at 90 degrees) at reference points P. In the example shown in FIG. 1, the travel path R along which the transport vehicle 1 travels connects the reference points P included in the reference point group PG. The travel path R shown in FIG. 1 extends from the infeeder 5 to the outfeeder 6 through the transfer area 3 (multiple transfer areas 3 in this example). In FIG. 1, the reference points P on the travel path R are indicated with solid rectangles, and other reference points P are indicated with outlined rectangles to distinguish the reference points P on the travel path R from the other reference points P.

As shown in FIG. 1, the reference points P are arranged at least at points that can be destinations of the traveling transport vehicle 1, such as the transfer areas 3, the infeeder 5, the outfeeder 6, and standby areas W (described later). The transport vehicle 1 includes a detector (not shown) for detecting the reference points P. When detecting a reference point P at a destination, the transport vehicle 1 stops. When detecting a reference point P at a point at which the transport vehicle 1 is to turn, the transport vehicle 1 turns.

In the present embodiment, the reference point P includes a detection target on the floor surface. The detection target included in the reference point P may be, for example, a one-dimensional code, a two-dimensional code, or a radio frequency (RF) tag. The detection target included in the reference point P stores specific identification information. The above detector included in the transport vehicle 1 reads the identification information stored in the detection target included in the reference point P to determine the current position of the transport vehicle 1. The identification information is, for example, address information indicating the position of the reference point P. The reference point P may not include the detection target. In this case, the transport vehicle 1 may determines its current position based on, for example, a detection signal from a global navigation satellite system (GNSS) receiver, and may stop or turn when the current position reaches the reference point P.

As described above, the travel path R connects multiple reference points P included in the reference point group PG. More specifically, the travel path R includes a path connecting two or more reference points P arranged in the first direction X, a path connecting two or more reference points P arranged in the second direction Y, or a combination of these. In the present embodiment, the transport vehicle 1 travels in one direction along each path, except a path connecting a reference point P in a transfer area 3 and its adjacent reference point P (the reference points P adjacent to each other in the second direction Y in the example shown in FIG. 1). The arrows along the paths in FIG. 1 indicate example travel directions of the transport vehicle 1.

Although described in detail later, the travel path R to connect the reference points P included in the reference point group PG includes a first path R1, a second path R2, a third path R3, a fourth path R4, a fifth path R5, and a sixth path R6 (refer to FIGS. 1 and 2). In the present embodiment, the travel path R further includes a seventh path R7 and an eighth path R8 (refer to FIG. 2). The travel path R to connect the reference points P in the reference point group PG includes a path combining multiple paths included in the eight paths (R1 to R8), or more specifically, a path combining at least sections of the respective paths. The travel path R illustrated in FIG. 1 includes all the eight paths described above.

As shown in FIG. 1, the reference points P included in the reference point group PG are arranged to define, as the travel path R, the first path R1, the second path R2, the third path R3, the fourth path R4, the fifth path R5, and the sixth path R6. As shown in FIG. 2, the reference points P included in the reference point group PG in the present embodiment are arranged to define, as the travel path R, at least one of the seventh path R7 or the eighth path R8 (both in this example).

As shown in FIGS. 1 and 2, the first path R1 extends toward the first side X1 in the first direction. The second path R2 is disposed on the first side Y1 in the second direction relative to the first path R1 and extends toward the first side X1 in the first direction. The third path R3 is disposed on the first side Y1 in the second direction relative to the second path R2 and extends toward the second side X2 in the first direction. The fourth path R4 is disposed on the first side Y1 in the second direction relative to the third path R3 and extends toward the second side X2 in the first direction.

In the present embodiment, the reference points P defining the first path R1 and the reference points P defining the second path R2 are adjacent to each other in the second direction Y. The reference points P defining the third path R3 and the reference points P defining the fourth path R4 are adjacent to each other in the second direction Y. Multiple reference points P are arranged as a group in the first direction X in at least a single row (a single row in this example) between the reference points P defining the second path R2 and the reference points P defining the third path R3 in the second direction Y. The reference points P arranged as a group in the first direction X define the eighth path R8 (described later).

The fifth path R5 extends toward the first side Y1 in the second direction and intersects with the second path R2 and the third path R3 to connect the first path R1 to the fourth path R4. The sixth path R6 extends toward the second side Y2 in the second direction and intersect with the second path R2 and the third path R3 at a different position from the fifth path R5 in the first direction X to connect the first path R1 to the fourth path R4. In the example shown in FIG. 1, three pairs of the fifth path R5 and the sixth path R6 are arranged in the first direction X (more specifically, each pair of the fifth path R5 and the sixth path R6 have a standby area W (described later) between them in the first direction X, or in other words, each pair of the fifth path R5 and the sixth path R6 define a target area T (described later)). In the example described below, the fifth path R5 and the sixth path R6 are in the same pair unless otherwise specified.

In the present embodiment, as shown in FIG. 2, the sixth path R6 is disposed on the first side X1 in the first direction relative to the fifth path R5. Multiple reference points P are arranged in the second direction Y in at least a single row (two rows in this example) between the reference points P defining the fifth path R5 and the reference points P defining the sixth path R6 in the first direction X. The reference points P arranged in the second direction Y define the seventh path R7 (described later).

In the present embodiment, the transfer areas 3 are arranged on the second side Y2 in the second direction relative to the first path R1. In this example, multiple transfer areas 3 are aligned in the first direction X on the second side Y2 in the second direction relative to the first path R1. In the example shown in FIG. 2, the transfer areas 3 are arranged on the second side Y2 in the second direction relative to the first path R1. The transfer areas 3 are at the positions corresponding to the respective fifth path R5, the sixth path R6, and the seventh path R7 (two seventh paths R7 in this example) in the first direction X. The reference points P in the transfer areas 3 on the second side Y2 in the second direction relative to the first path R1 are adjacent to the respective reference points P on the first path R1 on the second side Y2 in the second direction. The transport vehicle 1 enters and exits a transfer area 3 along a path connecting the two reference points P adjacent to each other in the second direction Y.

In the present embodiment, the transfer areas 3 are arranged on the first side Y1 in the second direction relative to the fourth path R4. In this example, multiple transfer areas 3 are aligned in the first direction X on the first side Y1 in the second direction relative to the fourth path R4. In the example shown in FIG. 2, the transfer areas 3 are arranged on the first side Y1 in the second direction relative to the fourth path R4. The transfer areas 3 are at the positions corresponding to the respective fifth path R5, the sixth path R6, and the seventh path R7 (two seventh paths R7 in this example) in the first direction X. The reference points P in the transfer areas 3 on the first side Y1 in the second direction relative to the fourth path R4 are adjacent to the respective reference points P on the fourth path R4 on the first side Y1 in the second direction. The transport vehicle 1 enters and exits a transfer area 3 along a path connecting the two reference points P adjacent to each other in the second direction Y.

As shown in FIG. 2, the travel surface 11 includes a standby area W in which the transport vehicles 1 waits. The standby area W is included in a target area T defined by four paths that are the second path R2, the third path R3, the fifth path R5, and the sixth path R6 on the travel surface 11. The standby area W is defined to prevent the transport vehicle 1 waiting in the standby area W and the article 2 supported by the transport vehicle 1 from interfering with another transport vehicle 1 and an article 2 supported by the transport vehicle 1 traveling on any of the four paths. In the example shown in FIG. 2, two transport vehicles 1 may align in the first direction X in the standby area W while waiting. In the present embodiment, the transport vehicle 1 waits in the standby area W while supporting the article 2.

The seventh path R7 extends toward the first side Y1 in the second direction or toward the second side Y2 in the second direction through the standby area W to connect the second path R2 to the third path R3. The eighth path R8 extends toward the first side X1 in the first direction or toward the second side X2 in the first direction through the standby area W to connect the fifth path R5 to the sixth path R6. The intersection (two intersections in the example shown in FIG. 2) between the seventh path R7 and the eighth path R8 is a waiting position for the transport vehicle 1 in the standby area W.

In the example shown in FIG. 2, one seventh path R7 extending toward the first side Y1 in the second direction, the other seventh path R7 extending toward the second side Y2 in the second direction, and the eighth path R8 extending toward the first side X1 in the first direction are definable. In the example shown in FIG. 2, one seventh path R7 further extends through a joint with the second path R2 to the first path R1. The other seventh path R7 further extends through a joint with the third path R3 to the fourth path R4. Although not shown, the eighth path R8 may further extend through a joint with the fifth path R5 or a joint with the sixth path R6 in the first direction X.

The transfer areas 3 are at multiple positions in the first direction X. In the present embodiment, the transfer areas 3 are aligned in the first direction X on the second side Y2 in the second direction relative to the first path R1 and aligned in the first direction X on the first side Y1 in the second direction relative to the fourth path R4. When the transport vehicle 1 is to wait for entry to a destination transfer area 3 (e.g., when another transport vehicle 1 is at the destination transfer area 3), the transport vehicle 1 preferentially selects a standby area W nearer the destination transfer area 3 as a waiting position. More specifically, the transport vehicle 1 selects, among the standby areas W with no other waiting transport vehicles 1, a standby area W nearest the destination transfer area 3 as a waiting position. Being nearer the transfer area 3 refers to a shorter travel path R from the standby area W to the transfer area 3. When the standby area W includes multiple waiting positions, the transport vehicle 1 preferentially selects a waiting position nearer the transfer area 3.

In the example shown in FIG. 1, three standby areas W, or a first standby area W1, a second standby area W2, and a third standby area W3 are defined. To reach three different transfer areas 3, or a first transfer area 31, a second transfer area 32, and a third transfer area 33, the transport vehicle 1 traveling along the travel path R illustrated in FIG. 1 waits in the first standby area W1, which is a standby area W nearest the first transfer area 31, until the transport vehicle 1 can enter the first transfer area 31. The transport vehicle 1 then waits in the second standby area W2, which is a standby area W nearest the second transfer area 32, until the transport vehicle 1 can enter the second transfer area 32. The transport vehicle 1 then waits in the third standby area W3, which is a standby area W nearest the third transfer area 33, until the transport vehicle 1 can enter the third transfer area 33.

The area defined by the four paths, or the first path R1, the fourth path R4, the fifth path R5, and the sixth path R6, is referred to as a unit area. The unit area substantially corresponds to the area shown in FIG. 2. More specifically, the unit area corresponds to an area extended from the target area T toward the second side Y2 in the second direction to the position of the first path R1 and toward the first side Y1 in the second direction to the position of the fourth path R4. In the example shown in FIG. 1, multiple unit areas (three unit areas in this example) are arranged on the same straight line in a plan view (as viewed in a direction perpendicular to the travel surface 11). This straight line extends laterally in the drawing when the FIG. 1 is viewed in a direction in which the reference numerals are readable. The first direction X and the second direction Y can be defined for each unit area. In the example shown in FIG. 1, the unit areas have the same orientation in the first direction X and in the second direction Y.

In the example shown in FIG. 1, the multiple unit areas are arranged on the same straight line in a plan view. In some embodiments, the multiple unit areas may be arranged on a curved line or a bent line in a plan view. In this case, the first path R1, the second path R2, the third path R3, and the fourth path R4 are defined along the curved line or the bent line in a plan view. The unit areas may have different orientations in the first direction X (the same applies to the second direction Y). For example, multiple unit areas may be arranged on an L-shaped line that bends at 90 degrees in a plan view. In this case, a unit area on one line of the L shape is referred to as a first unit area, and a unit area on the other line of the L shape as a second unit area. The first unit area has the first direction X corresponding to the second direction Y of the second unit area, and the second direction Y corresponding to the first direction X of the second unit area.

### Other Embodiments

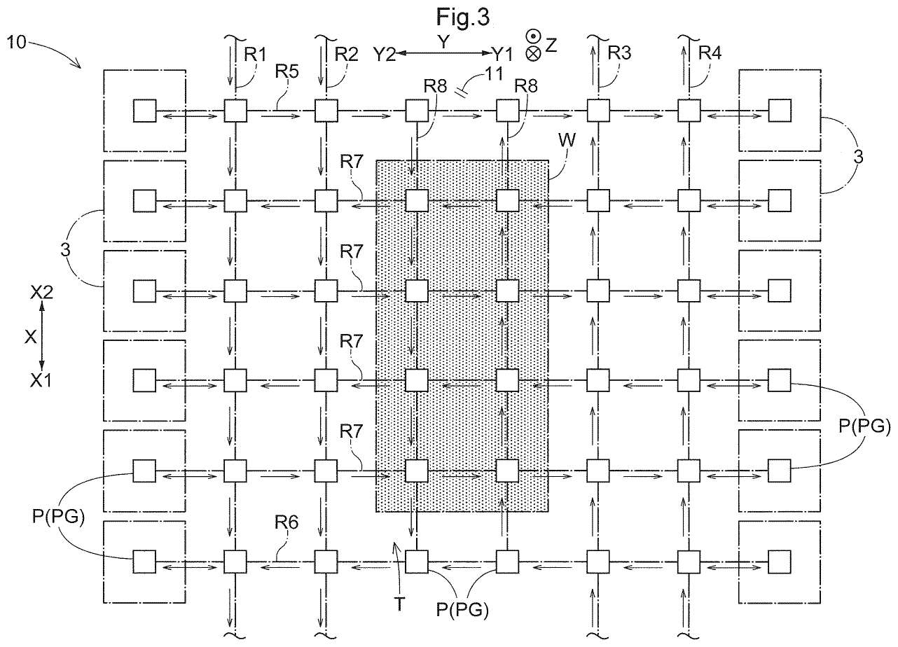

(1) In the above embodiment, two seventh paths R7 aligning in the first direction X and one eighth path R8 are definable, and the seventh paths R7 and the eighth path R8 have two intersections (in other words, two waiting positions for the transport vehicle 1 in the standby area W). However, the present disclosure is not limited to the above structure. As shown in FIG. 3, for example, the seventh paths R7 and the eighth paths R8 may have any number of intersections other than two. In the example shown in FIG. 3, four seventh paths R7 aligned in the first direction X and two eighth paths R8 aligned in the second direction Y are definable. The seventh paths R7 and the eighth paths R8 have eight intersections.

(2) In the above embodiment, the seventh path R7 extends toward the first side Y1 in the second direction or toward the second side Y2 in the second direction, and the eighth path R8 extends toward the first side X1 in the first direction or toward the second side X2 in the first direction. However, the present disclosure is not limited to the above structure. The seventh path R7 may be any path extending in the second direction Y. The seventh path R7 may include a section extending toward the first side Y1 in the second direction and a section extending toward the second side Y2 in the second direction. The eighth path R8 may be any path extending in the first direction X. The eighth path R8 may include a section extending toward the first side X1 in the first direction and a section extending toward the second side X2 in the first direction.

(3) In the above embodiment, the transfer areas 3 are arranged on both the sides in the second direction Y relative to the four paths, or the first path R1, the second path R2, the third path R3, and the fourth path R4. However, the present disclosure is not limited to the above structure. The transfer areas 3 may be arranged on either side alone in the second direction Y relative to these four paths.

(4) The structure described in each of the above embodiments may be combined with any other structures described in the other embodiments (including combinations of the other embodiments) unless any contradiction arises. This also applies to combinations of the embodiments described as other embodiments. For other structures as well, the embodiments described herein are merely illustrative in all aspects. Thus, the embodiments described herein may be modified variously as appropriate without departing from the spirit and scope of the disclosure.

### Overview Embodiment

An overview of the transport facility described above is provided below.

A transport facility includes a travel area including a reference point group including a plurality of reference points, and a transport vehicle that transports an article by traveling along a travel path connecting the plurality of reference points included in the reference point group. The plurality of reference points included in the reference point group are arranged to be capable of defining, as the travel path, a first path, a second path, a third path, a fourth path, a fifth path, and a sixth path. The first path extends toward a first side in a first direction along a travel surface on which the transport vehicle travels in the travel area. The second path is disposed on a first side in a second direction relative to the first path and extends toward the first side in the first direction. The second direction is a direction along the travel surface and intersecting with the first direction. The third path is disposed on the first side in the second direction relative to the second path and extends toward a second side in the first direction. The fourth path is disposed on the first side in the second direction relative to the third path and extends toward the second side in the first direction. The fifth path extends toward the first side in the second direction and intersects with the second path and the third path to connect the first path to the fourth path. The sixth path extends toward a second side in the second direction and intersects with the second path and the third path at a different position from the fifth path in the first direction to connect the first path to the fourth path. Four paths being the second path, the third path, the fifth path, and the sixth path define, on the travel surface, an area including at least one standby area in which the transport vehicle waits.

This structure can define, using multiple reference points included in the reference point group, two paths (more specifically, the first path and the second path) extending toward the first side in the first direction and two paths (more specifically, the third path and the fourth path) extending toward the second side in the first direction opposite to the first side in the first direction. This structure can further define two paths (more specifically, the fifth path and the sixth path) extending toward the opposite sides in the second direction at different positions in the first direction to connect the four paths. In this manner, the travel paths extending toward both the sides in the first direction and the travel paths extending toward both the sides in the second direction are directly or indirectly connectable to one another. Thus, the travel paths extending to the destinations for the transport vehicle can be defined as appropriate.

In this structure, the four paths being the second path, the third path, the fifth path, and the sixth path define, on the travel surface, the standby area in which the transport vehicle waits. The transport vehicle in the standby area defined as described above can wait without interfering with other transport vehicles traveling along these four paths. This allows the transport vehicle to wait while being least likely to affect other traveling transport vehicles.

The plurality of reference points included in the reference point group may be arranged to be capable of further defining, as the travel path, at least one of a seventh path or an eighth path. The seventh path may extend toward the first side in the second direction or toward the second side in the second direction through the at least one standby area to connect the second path to the third path. The eighth path may extend toward the first side in the first direction or toward the second side in the first direction through the at least one standby area to connect the fifth path to the sixth path.

In this structure, a travel path extending through the standby area can be appropriately defined using at least one of the seventh path or the eighth path to allow the transport vehicle to wait in the standby area. Similarly to the fifth and the sixth paths, the seventh path extends toward either side in the second direction. Similarly to the first, second, third, and fourth paths, the eighth path extends toward either side in the first direction. Thus, the transport facility can define a travel path including a standby area without greatly changing the arrangement of the multiple reference points included in the reference point group or the travel control of the transport vehicle.

The transport facility may further include a plurality of transfer areas at positions in the first direction. The plurality of transfer areas may be areas in which the article is transferred from or to the transport vehicle. The at least one standby area may include a plurality of standby areas. In response to the transport vehicle being to wait for entry to a destination transfer area among the plurality of transfer areas, the transport vehicle may preferentially select, among the plurality of standby areas, a standby area nearer the destination transfer area as a waiting position.

This structure allows selection of a standby area in which the transport vehicle waits to reduce the time taken for the transport vehicle to reach the destination transfer area when the transport vehicle is allowed for entry. This increases the transport efficiency of articles.

In the above structure, the plurality of transfer areas may include transfer areas aligned in the first direction on the second side in the second direction relative to the first path and transfer areas aligned in the first direction on the first side in the second direction relative to the fourth path.

In this structure, the first path and the fourth path are used as accessing paths to the transfer areas, and the second path and the third path are used as passing paths to pass, for example, another transport vehicle accessing a transfer area. This structure allows smooth traveling of the multiple transport vehicles, thus increasing the transport efficiency of the articles in the overall facility.

The transport facility according to one or more embodiments of the disclosure produces at least one of the effects described above.

### REFERENCE SIGNS LIST

1 transport vehicle
2 article
3 transfer area
10 travel area
11 travel surface
100 transport facility
P reference point
PG reference point group
R travel path
R1 first path
R2 second path
R3 third path
R4 fourth path
R5 fifth path
R6 sixth path
R7 seventh path
R8 eighth path
T target area (area defined on travel surface by four paths, or second path, third path, fifth path, and sixth path)
W standby area
X first direction
X1 first side in first direction
X2 second side in first direction
Y second direction
Y1 first side in second direction
Y2 second side in second direction

1-4. (canceled)

5. A transport facility, comprising:
a travel area comprising a reference point group comprising a plurality of reference points; and
a transport vehicle configured to transport an article by traveling along a travel path connecting the plurality of reference points comprised in the reference point group, and
wherein:
the plurality of reference points in the reference point group is arranged to be capable of defining, as the travel path, a first path, a second path, a third path, a fourth path, a fifth path, and a sixth path,
the first path extends toward a first side in a first direction along a travel surface on which the transport vehicle travels in the travel area,
the second path is disposed on a first side in a second direction relative to the first path and extends toward the first side in the first direction, the second direction is a direction along the travel surface and intersecting with the first direction,
the third path is disposed on the first side in the second direction relative to the second path and extends toward a second side in the first direction,
the fourth path is disposed on the first side in the second direction relative to the third path and extends toward the second side in the first direction,
the fifth path extends toward the first side in the second direction and intersects with the second path and the third path to connect the first path to the fourth path,
the sixth path extends toward a second side in the second direction and intersects with the second path and the third path at a different position from the fifth path in the first direction to connect the first path to the fourth path,
four paths comprising the second path, the third path, the fifth path, and the sixth path define, on the travel surface, an area comprising at least one standby area wherein the transport vehicle waits.

6. The transport facility according to claim 5, wherein:
reference points, among the plurality of reference points, defining the first path are adjacent to reference points, among the plurality of reference points, defining the second path in the second direction, and
reference points, among the plurality of reference points, defining the third path are adjacent to reference points, among the plurality of reference points, defining the fourth path in the second direction.

7. The transport facility according to claim 5, wherein:
the plurality of reference points in the reference point group are arranged to be capable of further defining, as the travel path, at least one of a seventh path or an eighth path,
the seventh path extends toward the first side in the second direction or toward the second side in the second direction through the at least one standby area to connect the second path to the third path, and
the eighth path extends toward the first side in the first direction or toward the second side in the first direction through the at least one standby area to connect the fifth path to the sixth path.

8. The transport facility according to claim 7, wherein:
the plurality of reference points in the reference point group are arranged to be capable of defining, as the travel path, both the seventh path and the eighth path, and
an intersection between the seventh path and the eighth path is a waiting position for the transport vehicle in the at least one standby area.

9. The transport facility according to claim 5, further comprising:
a plurality of transfer areas at positions in the first direction, the plurality of transfer areas comprising areas wherein the article is transferred from or to the transport vehicle,
wherein the at least one standby area comprises a plurality of standby areas, and
wherein in response to the transport vehicle having to wait for entry to a destination transfer area among the plurality of transfer areas, the transport vehicle preferentially selects, among the plurality of standby areas, a standby area nearer the destination transfer area as a waiting position.

10. The transport facility according to claim 5, wherein:
the plurality of transfer areas comprise transfer areas aligned in the first direction on the second side in the second direction relative to the first path and transfer areas aligned in the first direction on the first side in the second direction relative to the fourth path.
